(19) United States
(12) Patent Application Publication
(10) Pub. No.: US 2007/0135302 A1
(43) Pub. Date: Jun. 14, 2007

(54) Mehtod for the production of a catalyst for gas-phase oxidations by the coating of support materials in a fluid bed apparatus

(76) Inventors: Samuel Neto, Mannheim (DE); Wolfgang Rummel, Koln (DE); Sebastien Storck, Mannheim (DE); Jurgen Zuhlke, Speyer (DE); Frank Rosowski, Mannheim (DE)

Correspondence Address: CONNOLLY BOVE LODGE & HUTZ, LLP, P O BOX 2207, WILMINGTON, DE, 19899, US

(21) Appl. No.: 10/573,480

(22) PCT Filed: Sep. 24, 2004
(86) PCT No.: PCT/EP04/10750

§ 371 Date: Jul. 26, 2006

(30) Foreign Application Priority Data
Sep. 26, 2003 (DE) 103 44 844.6
Feb. 16, 2004 (EP) 04003444.9

(51) Int. Cl. B01J 23/00

(52) U.S. Cl. 502/300

(57) ABSTRACT

The invention relates to a process for producing a catalyst for gas-phase oxidations, which comprises weighing a particulate inert support having a total mass of Mₛᵤₚₚₒᵣₜ into a fluidized-bed apparatus, providing an aqueous suspension of a catalytically active material or sources therefor and a binder having a binder content of Bₛᵤₛₚ, fluidizing the inert support by introduction of a gas stream heated to a temperature of T_{gas} at a flow rate of Q_{gas}, and spraying the suspension at a rate of Qₛᵤₛₚ onto the fluidized inert support. When Q_{gas}, Qₛᵤₛₚ, Bₛᵤₛₚ, Mₛᵤₚₚₒᵣₜ and T_{gas} are selected within the ranges
3000≦Q_{gas} [m³/h]≦9000, 1000≦Qₛᵤₛₚ [g/min]≦3500,
2≦Bₛᵤₛₚ [% by weight]≦18, 60≦Mₛᵤₚₚₒᵣₜ [kg]≦240.
75≦T_{gas} [° C.]≦120 so that a parameter K defined as
   K=0.020 Q_{gas}−0.055 Qₛᵤₛₚ+7.500 Bₛᵤₛₚ−0.667 Mₛᵤₚₚₒᵣₜ+2.069 T_{gas}−7 satisfies the relationship 127.5≦K≦202, high-quality coatings can be produced and the formation of twins made up of support particles adhering to one another can be avoided.

Process for producing a catalyst for gas-phase oxidations, and also the use of the catalyst for the catalytic gas-phase oxidation of aromatic hydrocarbons to carboxylic acids and/or carboxylic anhydrides, in particular for the preparation of phthalic anhydride from o-xylene, naphthalene or mixtures thereof.

Many carboxylic acids and/or carboxylic anhydrides are prepared industrially by the catalytic gas-phase oxidation of aromatic hydrocarbons such as benzene, the xylenes, naphthalene, toluene or durene in fixed-bed reactors. In this way, it is possible to obtain, for example, benzoic acid, maleic anhydride, phthalic anhydride, isophthalic acid, terephthalic acid or pyromellitic anhydride. In general, a mixture of an oxygen-containing gas and the starting material to be oxidized is passed through tubes in which a bed of a catalyst is located. To regulate the temperature, the tubes are surrounded by a heat transfer medium, for example a salt melt.

Catalysts which have been found to be useful for these oxidation reactions are coated catalysts in which the catalytically active composition is applied in the form of a shell to an inert support material such as steatite. Compositions of differing catalytic activity can be applied in one or more layers. The catalytically active constituent of the catalytically active composition of these coated catalysts is generally titanium dioxide together with vanadium pentoxide. Furthermore, small amounts of many other oxidic compounds which act as promoters to influence the activity and selectivity of the catalyst can be present in small amounts in the catalytically active composition.

To produce such coated catalysts, an aqueous suspension of the constituents of the active composition and/or their precursor compounds or sources is sprayed onto the support material at elevated temperature until the desired proportion by weight of active composition in the total catalyst has been achieved. Fluidized-bed apparatuses are particularly suitable for this purpose. In these apparatuses, the support material is fluidized in an ascending stream of gas, in particular air. The apparatuses usually comprise a conical or spherical container into which the fluidizing gas is introduced from below or from above via a central tube. The suspension is sprayed into the fluidized bed from above, from the side or from below by means of nozzles. The use of a guide tube arranged centrically or concentrically around the central tube is advantageous. Within the guide tube, the gas velocity is higher and transports the support particles upward. In the outer ring, the velocity is only slightly above the loosening velocity. The particles are therefore transported vertically in a circular motion.

A suitable fluidized-bed apparatus is described, for example, in DE-A 40 06 935.

To improve the quality of the coating, it has become established practice in industry to add organic binders, preferably copolymers, advantageously in the form of an aqueous suspension, of vinyl acetate-vinyl laurate, vinyl acetate-acrylate, styrene-acrylate or vinyl acetate-ethylene, to the suspension. Furthermore, the addition of binder has the advantage that the active composition adheres well to the support, so that transport and installation of the catalyst are made easier.

In the thermal treatment at temperatures of from >80 to 450° C., the binder is driven off from the applied layer by thermal decomposition and/or combustion. The thermal treatment is usually carried out in situ in the oxidation reactor.

The quality of the supported catalysts obtainable in this way, in particular the coating quality, depends decisively on operating parameters of the fluidized-bed apparatus, in particular on the total mass of support material in the apparatus, the binder content of the suspension sprayed in, the flow rate and the temperature of the gas stream blown in for fluidization and the rate at which the suspension is sprayed onto the fluidized inert support. The setting of the most important operating parameters of the fluidized-bed apparatus for coating the support materials is in the prior art carried out by means of costly empirical trials which have to be carried out on the production scale since scale-up from the laboratory or pilot plant scale to the production scale is virtually impossible because of the lack of satisfactory theoretical models.

WO 98 14274 describes a process for producing a supported catalyst in a fluidized-bed apparatus, in which a less than 100 μm layer of an active composition in aqueous suspension is applied to an inert support having a diameter of 5 μm-20 mm.

WO 02 096557 describes a process for producing supported metallic nanoparticles as catalysts in a fluidized-bed apparatus.

U.S. Pat. No. 4,977,126 describes a process for preparing supported catalysts in a fluidized-bed apparatus, in which the catalysts comprise a layer of metallic cobalt on oxide supports.

FR 2 791 905 describes a process for producing supported catalysts, in which the suspension comprises fine particles having a diameter of 10-100 μm and a density of more than 1000 kg/m³ and contains about 30% of coarser particles having diameters of 0.4-1 mm.

However, these documents describe neither catalysts for gas-phase oxidations nor the coating of rings.

It is therefore an object of the invention to provide a process for producing a catalyst for gas-phase oxidations in a fluidized-bed apparatus, in which a uniform and reproducible coating of a support material is obtained without costly preliminary experiments.

It has surprisingly been found that this object can be achieved when the amount of support material weighed into the apparatus, the throughput and the temperature of the gas stream introduced, and also the rate of introduction and the binder content of the suspension sprayed in are selected within particular prescribed ranges in such a way that these parameters obey a simple empirically determined mathematical relationship.

The invention relates to a process for producing a catalyst for gas-phase oxidations, which comprises weighing a particulate inert support having a total mass of Mₛᵤₚₚₒᵣₜ into a fluidized-bed apparatus, providing-at least an aqueous suspension of a catalytically active material or sources therefor and a binder having a binder content of Bₛᵤₛₚ, fluidizing the inert support by introduction of a gas stream heated to a temperature of T_{gas} at a flow rate of Q_{gas}, and spraying the suspension at a rate of Qₛᵤₛₚ onto the fluidized inert support.

According to the invention, Q_{gas}, Q_{susp, B}ₛᵤₛₚ, Mₛᵤₚₚₒᵣₜ and T_{gas} are selected within the ranges
3000≦Q_{gas} [m³/h]≦9000, 1000≦Qₛᵤₛₚ [g/min]≦3500,
2≦Bₛᵤₛₚ [% by weight]≦18, 60≦Mₛᵤₚₚₒᵣₜ [kg]≦240.
75≦T_{gas} [° C.]≦120
   so that a parameter K defined as
   K=0.020 Q_{gas}−0.055 Qₛᵤₛₚ+7.500 Bₛᵤₛₚ−0.667 Mₛᵤₚₚₒᵣₜ+2.069 T_{gas}−7
   satisfies the relationship 127.5≦K≦202.

When the operating parameters satisfy this relationship, high-quality layers are produced. In particular, the formation of twins, i.e. support bodies which adhere to one another, for example as a result of insufficient drying or too much binder, is avoided. In addition, very little if any attrition due to flaking-off of layers occurs. The layers themselves are also more uniform, both when the supports are coated with one layer and with two layers, than in a coating process in which one or more parameters do not obey the above relationship.

The mechanical stability of the layer on the support is also improved.

In the process of the invention, the application of the layer(s) of the coated catalyst is carried out, for example, by spraying a suspension of TiO₂ and V₂O₅, which comprises, if appropriate, sources of the promoter elements specified below, onto the fluidized support. The catalytically active composition in the calcined state preferably comprises, based on the total amount of catalytically active composition, from 1 to 40% by weight of vanadium oxide, calculated as V₂O₅, and from 60 to 99% by weight of titanium dioxide, calculated as TiO₂.

As vanadium source, preference is given to using pulverulent vanadium pentoxide (V⁵⁺) or dissolved vanadium, e.g. vanadyl oxalate (V⁴⁺). Suitable starting compounds for the element vanadium are, for example, vanadium oxides such as vanadium pentoxide (V₂O₅), vanadates such as ammonium metavanadate, vanadium oxysulfate hydrate, vanadyl acetylacetonate, vanadium halides such as vanadium tetrachloride (VCl₄) and vanadium oxyhalides such as VOCl₃. In addition, it is also possible to make use of vanadium starting compounds in which the vanadium is present in the oxidation state +4 or which comprise vanadium in the oxidation state +5 and various reducing agents (e.g. NH₄⁺ or its decomposition product NH₃) which can reduce V⁵⁺ to V⁴⁺. Such a reducing agent can also be oxalic acid, oxalate, hydrazine dihydrochloride, hydrazine sulfate, hydrazine (monohydrate), hydroxylamine, hydroxylamine hydrochloride or salts thereof.

The catalytically active composition can further comprise up to 1% by weight of a cesium compound, calculated as Cs, up to 1% by weight of a phosphorus compound, calculated as P, and up to 10% by weight of antimony oxide, calculated as Sb₂O₃.

Apart from the optional additives cesium and phosphorus, the catalytically active composition can in principle contain small amounts of many other oxidic compounds which act as promoters to influence the activity and selectivity of the catalyst, for example reducing or increasing its activity. Examples of such promoters are the alkali metal oxides, in particular the abovementioned cesium oxide and also lithium, potassium and rubidium oxide, thallium(I) oxide, aluminum oxide, zirconium oxide, iron oxide, nickel oxide, cobalt oxide, manganese oxide, tin oxide, silver oxide, copper oxide, chromium oxide, molybdenum oxide, tungsten oxide, iridium oxide, tantalum oxide, niobium oxide, arsenic oxide, cerium oxide. In general, cesium is used as promoter from this group.

Among the promoters mentioned, preferred additives also include the oxides of niobium and tungsten in amounts of from 0.01 to 0.50% by weight, based on the catalytically active composition. As additives which increase the activity but decrease the selectivity, particular mention may be made of oxidic phosphorus compounds, in particular phosphorus pentoxide.

Before carrying out the coating procedure, the suspension is preferably stirred for a sufficiently long time, e.g. from 2 to 30 hours, in particular from 12 to 25 hours, to break up agglomerates of the suspended solids and to produce a homogeneous suspension. The suspension typically has a solids content of from 20 to 50% by weight. The suspension medium is generally aqueous, e.g. water itself or an aqueous mixture with a water-miscible organic solvent such as methanol, ethanol, isopropanol, formamide and the like. If the first or second suspension comprises TiO₂ and V₂O₅ particles as catalyst particles, preference is given to at least 90% by volume of the V₂O₅ particles having a diameter of 20 μm or less and at least 95% by volume of the V₂O₅ particles having a diameter of 30 μm or less.

In general, organic binders, preferably copolymers, advantageously in the form of an aqueous dispersion, of vinyl acetate-vinyl laurate, vinyl acetate-acrylate, styrene-acrylate and vinyl acetate-ethylene, are added to the suspension. The binders are commercially available as aqueous dispersions having a solids content of, for example, from 35 to 65% by weight. The amount of such binder dispersions used is, according to the invention, from 2 to 18% by weight, based on the weight of the suspension.

When the catalysts support is coated with the catalytically active composition, coating temperatures of from 75 to 120° C. are employed according to the invention, with coating being able to be carried out under atmospheric pressure or under reduced pressure.

The layer thickness of the catalytically active composition is generally from 0.02 to 0.25 mm, preferably from 0.05 to 0.20 mm. The proportion of active composition in the catalyst is usually from 5 to 25% by weight, mostly from 7 to 15% by weight.

Thermal treatment of the resulting precatalyst at temperatures of >80 to 450° C. drives the binder off from the applied layer as a result of thermal decomposition and/or combustion. The thermal treatment is preferably carried out in situ in the gas-phase oxidation reactor.

The parameter K is preferably in a range 136.0≦K≦193.5 and
4500≦Q_{gas} [m³/h]≦7500, 1500≦Qₛᵤₛₚ [g/min]≦3000,
5≦Bₛᵤₛₚ [% by weight]≦15, 100≦Mₛᵤₚₚₒᵣₜ [kg]≦200, and
80≦T_{gas} [° C.]≦115.

The parameter K is particularly preferably in a range 143≦K≦184.5 and
5500≦Q_{gas}[m³/h]≦6500, 2000≦Qₛᵤₛₚ [g/min]≦2500,
6≦Bₛᵤₛₚ [% by weight]≦11 120≦Mₛᵤₚₚₒᵣₜ [kg]≦180,
90≦T_{gas} [° C.]≦115.

To fluidize and heat the bed of support material in the fluidized-bed apparatus, it is possible to use any gas or gas mixture which is inert under the operating conditions. However, the gas introduced is advantageously air, which makes particularly inexpensive operation of the plant possible.

The catalytically active composition can also be applied in two or more layers. The layers preferably have different selectivities and activities. For example, the inner layer or inner layers can have an antimony oxide content of up to 15% by weight and the outer layer can have an antimony oxide content which is from 50 to 100% lower. For example, the inner and outer layers may have different phosphorus contents. To prepare catalysts having two layers according to the invention, a second aqueous suspension is prepared from catalytically active material and is sprayed onto the fluidized support which has been coated with the first suspension.

As inert support material, it is possible to use virtually all support materials of the prior art, as are used advantageously in the production of coated catalysts for the oxidation of aromatic hydrocarbons to aldehydes, carboxylic acids and/or carboxylic anhydrides. Support materials used are, for example, silica (SiO₂), porcelain, magnesium oxide, tin dioxide, silicon carbide, rutile, alumina (Al₂O₃), aluminum silicate, steatite (magnesium silicate), zirconium silicate, cerium silicate or mixtures of these support materials. The support material is generally nonporous. For the purposes of the present invention, the expression “nonporous” means “nonporous except for technically insignificant amounts of pores”, since a small number of pores may be unavoidably present under industrial conditions in a support material which should ideally contain no pores. Advantageous support materials are, in particular, steatite and silicon carbide. The shape of the support material is generally not critical for the precatalysts and coated catalysts according to the invention. For example, catalyst supports in the form of spheres, rings, pellets, spirals, tubes, extrudates or crushed material can be used. The dimensions of these catalyst supports correspond to those of catalyst supports customarily used for producing coated catalysts for the gas-phase partial oxidation of aromatic hydrocarbons. Preference is given to using steatite in the form of spheres having an external diameter of from 0.5 to 10 mm or rings having an external diameter of from 3 to 15 mm.

The process of the invention is particularly preferably carried out in a fluidized-bed apparatus which is a container for accommodating the particulate support in whose lower region a dish-like depression is provided and which comprises a central tube for introducing the gas which extends essentially axially downward in the container and opens into the depression, an essentially annular deflection shield which is fixed to the central tube in the upper region of the container and a guide ring which is located in the lower region of the container and surrounds the central tube essentially concentrically over part of its length and means for spraying-in the first and, if applicable, second suspension. Such a fluidized-bed apparatus is described, for example, in the German patent application DE 40 06 935. Commerically available fluidized-bed apparatuses which are suitable for carrying out the process of the invention are, for example, the Kugel-Coater HKC 150 and HKC 200 from Hüttlin, Steinen, Germany.

The catalysts produced according to the invention are suitable in general for the gas-phase oxidation of aromatics C₆-C₁₀-hydrocarbons such as benzene, the xylenes, toluene, naphthalene or durene (1,2,4,5-tetramethylbenzene) to carboxylic acids and/or carboxylic anhydrides such as maleic anhydride, phthalic anhydride, benzoic acid and/or pyromellitic anhydride. The invention therefore also provides for the use of the catalyst produced by the process of the invention for preparing phthalic anhydride from o-xylene, naphthalene or mixtures thereof.

For this purpose, the catalysts produced according to the invention are placed in reaction tubes which are thermostated from the outside to the reaction temperature, for example by means of salt melts, and the salt bath temperatures of generally from 300 to 450° C., preferably from 320 to 420° C. and particularly preferably from 340 to 400° C. and at a gauge pressure of generally from 0.1 to 2.5 bar, preferably from 0.3 to 1.5 bar, are passed at a space velocity of generally from 750 to 5000 h⁻¹. The reaction gas supplied to the catalyst is generally produced by mixing a gas which comprises molecular oxygen and may, in addition to oxygen, further comprise suitable reaction moderators and/or diluents such as steam, carbon dioxide and/or nitrogen with the aromatic hydrocarbon to be oxidized, with the gas comprising molecular oxygen generally being able to comprise from 1 to 100 mol %, preferably from 2 to 50 mol % and particularly preferably from 10 to 30 mol %, of oxygen, from 0 to 30 mol %, preferably from 0 to 10 mol %, of water vapor and from 0 to 50 mol %, preferably from 0 to 1 mol %, of carbon dioxide, balance nitrogen. To produce the reaction gas, the gas comprising molecular oxygen is generally loaded with from 30 g to 150 g of the aromatic hydrocarbon to be oxidized per standard m³ of gas. It has been found to be particularly advantageous to use catalysts which differ in terms of the catalytic activity and/or the chemical make-up of their active composition in the catalyst bed. When using two reaction zones, the catalyst employed in the first reaction zone, i.e. the reaction zone nearest the gas inlet for the reaction gas, usually has a somewhat lower catalytic activity than the catalyst present in the second reaction zone, i.e. the reaction zone nearest the gas outlet. In general, the reaction is controlled by means of the temperature setting so that the major part of the aromatic hydrocarbon present in the reaction gas is reacted at maximum yield in the first zone. Preference is given to using three- to five-zone catalyst systems, in particular three- and four-zone catalyst systems.

The invention is illustrated by the following examples.

### EXAMPLE 1

### Single-Layer Catalyst on Conventional Support Rings

47.44 kg of anatase (BET surface area: 9 m²/g), 20.34 kg of anatase (BET surface area: 20 m²/g), 5.32 kg of vanadium pentoxide, 1.33 kg of antimony oxide, 0.30 kg of cesium carbonate were suspended in 195 l of deionized water and stirred for 18 hours to obtain a homogeneous dispersion. 30.6 kg of an organic binder consisting of a copolymer of vinyl acetate and vinyl laurate in the form of a 50% strength aqueous dispersion were added to this suspension.

In a fluidized-bed apparatus (Hüttlin HKC 150), 60 kg of this suspension were sprayed onto 150 kg of steatite (magnesium silicate) in the form of rings having dimensions of 7 mm×7 mm×4 mm (external diameter×height×internal diameter) and dried. The operating parameters were
Air flow: 6000 m³/h
Introduction rate: 2250 g/min
Binder concentration: 10% by weight of the total suspension used
Weight of supports: 150 kg of steatite rings (7 mm×7 mm×4 mm)
Temperature of air fed in: 109° C.

The catalytically active composition applied in this way, i.e. the catalyst coating, comprised 7.12% by weight of vanadium (calculated as V₂O₅), 1.8% by weight of antimony (calculated as Sb₂O₃), 0.33% by weight of cesium (calculated as Cs) and 90.75% by weight of titanium dioxide after calcination at 450° C. for one hour. The weight of the applied coating was 8.0% of the total weight of the finished catalyst.

The parameter K calculated from the equation in claim 1 is 188.5.

The amount of abraded material after a triple drop test was 25% by weight (after calcination at 450° C. for one hour). In the drop test, about 50 g of catalyst (calcined after thermal treatment for one hour at 450° C.) were allowed to drop through a 3 m long tube having an internal diameter of 25 mm. The catalyst falls into a dish standing under the tube, is separated from the dust formed on impact and is again allowed to drop through the tube. The total mass loss in the triple drop test based on the amount of active composition applied, which corresponds to 100%, is a measure of the abrasion resistance of the catalyst.

### Comparative Example 2

The catalyst was prepared as in example 1, with the operating conditions of the fluidized-bed apparatus being set as follows:
Air flow: 6000 m³/h
Introduction rate: 2250 g/min
Binder concentration: 10% by weight of the total suspension used
Weight of supports: 150 kg of steatite rings (7 mm×7 mm×4 mm)
Temperature of air fed in: 70° C.

The parameter K calculated from the equation in claim 1 is 107.8.

When the temperature of the air fed in was below the range according to the invention, many twin rings which obviously resulted from insufficient drying were found. The amount of abraded material after the triple drop test (drop test as in example 1) was 40%.

### Comparative Example 3

The catalyst was prepared as in example 1, with the operating conditions of the fluidized-bed apparatus being set as follows:
Air flow: 6000 m³/h
Introduction rate: 2250 g/min
Binder concentration: 20% by weight of the total suspension used
Weight of supports: 150 kg of steatite rings (7 mm×7 mm×4 mm)
Temperature of air fed in: 109° C.

The parameter K calculated from the equation in claim 1 is 263.5.

At a binder concentration above the range specified according to the invention, many twin rings were also found. The amount of abraded material after the triple drop test (drop test as in example 1) was 40%.

### EXAMPLE 4

### Single-Layer Catalyst on Larger Support Rings

150 kg of steatite in the form of rings having dimensions of 8 mm×6 mm×5 mm (external diameter×height×internal diameter) were heated in a fluidized-bed apparatus (Hüttlin HKC 150) and sprayed with 57 kg of a suspension comprising 140.02 kg of anatase having a BET surface area of 21 m²/g, 11.776 kg of vanadium pentoxide, 31.505 kg of oxalic acid, 5.153 kg of antimony trioxide, 0.868 kg of ammonium hydrogenphosphate, 0.238 g of cesium sulfate, 215.637 kg of water and 44.808 kg of formamide together with 33.75 kg of an organic binder consisting of a copolymer of acrylic acid-maleic acid (weight ratio=75:25) until the weight of the layer applied was 10.5% of the total weight of the finished catalyst (after heat treatments at 450° C. for one hour). The catalytically active composition applied in this way, i.e. the catalyst coating, comprised on average 0.15% by weight of phosphorus (calculated as P), 7.5% by weight of vanadium (calculated as V₂O₅), 3.2% by weight of antimony (calculated as Sb₂O₃), 0.1% of cesium (calculated as Cs) and 89.05% by weight of titanium dioxide. The operating conditions of the fluidized-bed apparatus were:
Air flow: 6500 m³/h
Introduction rate: 2250 g/min
Binder concentration: 7.5% by weight of the total suspension used
Weight of supports: 150 kg of steatite rings (8 mm×6 mm×5 mm)
Temperature of air fed in: 97° C.

The parameter K calculated from the equation in claim 1 is 154.9. The amount of abraded material after the triple drop. test (drop test as in example 1) was 5% by weight (after calcination at 450° C. for one hour).

### Comparative Example 5

The catalyst was prepared as in example 4, with 19 kg of the suspension being sprayed and the operating conditions of the fluidized-bed apparatus being set as follows:
Air flow: 650 m³/h
Introduction rate: 2250 g/min
Binder concentration: 7.5% by weight of the total suspension used
Weight of supports: 50 kg of steatite rings (8 mm×6 mm×5 mm)
Temperature of air fed in: 97° C.

The parameter K calculated from the equation in claim 1 is 221.6.

In this comparative example in which the weight of support material was below the range specified according to the invention, many twin rings were once again found. The amount of abraded material after the triple drop test (drop test as in example 1) was 34%.

### Comparative Example 6

The catalyst was prepared as in example 4, with the operating conditions of the fluidized-bed apparatus being set as follows:
Air flow: 6500 m³/h
Introduction rate: 900 g/min
Binder concentration: 7.5% by weight of the total suspension used
Weight of supports: 150 kg of steatite rings (8 mm×6 mm×5 mm)
Temperature of air fed in: 97° C.

The parameter K calculated from the equation in claim 1 is 229.9.

At a rate of introduction of the suspension which was too low, many flaked coated catalysts were found. The amount of abraded material after the triple drop test (drop test as in example 1) was 51%.

### EXAMPLE 7

### Two-Layer Catalyst

Suspension 1:

150 kg of steatite in the form of rings having dimensions of 8 mm×6 mm×5 mm (external diameter×height×internal diameter) were heated in a fluidized-bed apparatus (Hüttlin HKC 150) and sprayed with 24 kg of a suspension comprising 155.948 kg of anatase having a BET surface area of 21 m²/g, 13.193 kg of vanadium pentoxide, 35.088 kg of oxalic acid, 5.715 kg of antimony trioxide, 0.933 kg of ammonium hydrogenphosphate, 0.991 g of cesium sulfate, 240.160 kg of water and 49.903 kg of formamide together with 37.5 kg of an organic binder consisting of a copolymer of acrylic acid-maleic acid (weight ratio=75:25).

Suspension 2:

150 kg of the coated catalyst obtained were heated in a fluidized-bed apparatus and sprayed with 24 kg of a suspension comprising 168.35 kg of anatase having a BET surface area of 21 m²/g, 7.043 kg of vanadium pentoxide, 19.080 kg of oxalic acid, 0.990 g of cesium sulfate, 238.920 kg of water and 66.386 kg of formamide together with 37.5 kg of an organic binder consisting of a copolymer of acrylic acid-maleic acid (weight ratio=75:25).

Operating conditions of the fluidized-bed apparatus during spraying-on of both layers:
Air flow: 6500 m³/h
Introduction rates: in each case 2250 g/min
Binder concentration: 7.5% by weight of the total suspension used
Weight of supports: 150 kg of steatite rings (8 mm×6 mm×5 mm)
Temperature of air fed in: 97° C.

The parameter K calculated from the equation in claim 1 is 154.9.

The weight of the layers applied was 9.3% of the total weight of the finished catalyst (after heat treatment at 450° C. for one hour). The catalytically active composition applied in this way, i.e. the catalyst coatings, was on average 0.08% by weight of phosphorus (calculated as P), 5.75% by weight of vanadium (calculated as V₂O₅), 1.6% by weight of antimony (calculated as Sb₂O₃), 0.4% by weight of cesium (calculated as Cs) and 92.17% by weight of titanium dioxide.

The amount of abraded material after the triple drop test (drop test as in example 1) was 10% by weight (after calcination at 450° C. for one hour).

### Comparative Example 8

A two-layer catalyst was prepared as in example 7, with the operating conditions of the fluidized-bed apparatus being set as follows:
Air flow: 2900 m³/h
Introduction rate: 2250 g/min
Binder concentration: 7.5% by weight of the total suspension used
Weight: 150 kg of steatite rings (8×6×5 mm)
Temperature of air fed in: 97° C.

The parameter K calculated from the equation in claim 1 is 82.9.

At an air flow which is too low, many twin rings and catalysts with flaked coatings were found. The amount of abraded material after the triple drop test (drop test as in example 1) was 64%.

### Comparative Example 9

A two-layer catalyst was prepared as in example 7, with the operating conditions of the fluidized-bed apparatus being set as follows:
Air flow: 6500 m³/h
Introduction rate: 2250 g/min
Binder concentration: 7.5% by weight of the total suspension used
Weight of supports: 150 kg of steatite rings (8 mm×6 mm×5 mm)
Temperature of air fed in: 125° C.

The parameter K calculated from the equation in claim 1 is 212.8.

At a temperature of the air fed in which was too high, many catalysts with flaked coatings were found. The amount of abraded material after the triple drop test (drop test as in example 1) was 65%.

1. A process for producing a catalyst for gas-phase oxidations, which comprises
weighing a particulate inert support having a total mass of Mₛᵤₚₚₒᵣₜ into a fluidized-bed apparatus,
providing an aqueous suspension of a catalytically active material or sources thereof and a binder having a binder content of Bₛᵤₛₚ,
fluidizing the inert support by introduction of a gas stream heated to a temperature of T_{gas} at a flow rate of Q_{gas}, and
spraying the suspension at a rate of Qₛᵤₛₚ onto the fluidized inert support,
wherein:
Q_{gas} is from 3,000 m³/h to 9,000 m³/h,
Qₛᵤₛₚ is from 1,000 g/min to 3,500 g/min,
Bₛᵤₛₚ is from 2% by weight to 18% by weight of the total suspension,
Mₛᵤₚₚₒᵣₜ is from 60 kg to 240 kg, and
T_{gas} is from 75° C. to 120° C.
so that a paramenter K defined as
K=0.020 Q_{gas}−0.055 Qₛᵤₛₚ+7.500 Bₛᵤₛₚ−0.667 Mₛᵤₚₚₒᵣₜ+2.069 T_{gas}−7
satisfies the relationship 127.5≦K≦202.

2. The process according to claim 1, wherein the parameter K is in a range 136.0≦K≦193.5 and
Q_{gas} is from 4,500 m³/h to 7,500 m³/h,
Qₛᵤₛₚ is from 1,500 g/min to 3,000 g/min,
Bₛᵤₛₚ is from 5% by weight to 15% by weight of the total suspension,
Mₛᵤₚₚₒᵣₜ is from 100 kg to 200 kg, and
T_{gas} is from 80° C. to 115° C.

3. The process according to claim 2, wherein the parameter K is in a range 143≦K≦184.5 and
Q_{gas} is from 5,500 m³/h to 6,500 m³/h,
Qₛᵤₛₚ is from 2,000 g/min to 2,500 g/min,
Bₛᵤₛₚ is from 6% by weight to 11% by weight of the total suspension,
Mₛᵤₚₚₒᵣₜ is from 120 kg to 180 kg, and
T_{gas} is from 90° C. to 115° C.

4. The process according to claim 1, wherein the gas which is introduced is air.

5. The process according to claim 1, wherein a second aqueous suspension of catalytically active material and binder is provided and is sprayed onto the fluidized support which has been coated with the first suspension.

6. The process according to claim 5, wherein the support which has been coated with the first suspension is dried before the second suspension is sprayed onto it.

7. The process according to claim 1, wherein the particulate inert support is provided in the form of spheres, cylinders, rings or columns.

8. The process according to claim 1, wherein the fluidized-bed apparatus is a container for accommodating the particulate support in whose lower region a dish-like depression is provided and which comprises a central tube for introducing the gas which extends essentially axially downward in the container and opens into the depression, an essentially annular deflection shield which is fixed to the central tube in the upper region of the container and a guide ring which is located in the lower region of the container and surrounds the central tube essentially concentrically over part of its length and means for spraying-in the first and, if applicable, second suspension.

9. The process according to claim 8, wherein the first or second suspension comprises TiO₂ and V₂O₅ particles, where at least 90% by volume of the V₂O₅ particles have a diameter of 20 μm or less and at least 95% by volume of the V₂O₅ particles have a diameter of 30 μm or less.

10. The process according to claim 1, wherein V₂O₅ particles or dissolved vanadium is used for the first or second suspension.

11. The use of the catalyst prepared according to claim 1 for preparing phthalic anhydride from o-xylene, naphthalane, or mixtures thereof.

12. The process according to claim 2, wherein the gas which is introduced is air.

13. The process according to claim 3, wherein the gas which is introduced is air.

14. The process according to claim 2, wherein a second aqueous suspension of catalytically active material and binder is provided and is sprayed onto the fluidized support which has been coated with the first suspension.

15. The process according to claim 3, wherein a second aqueous suspension of catalytically active material and binder is provided and is sprayed onto the fluidized support which has been coated with the first suspension.

16. The process according to claim 4, wherein a second aqueous suspension of catalytically active material and binder is provided and is sprayed onto the fluidized support which has been coated with the first suspension.

17. The process according to claim 1, wherein the particulate inert support is provided in the form of spheres, cylinders, rings or columns, with dimensions of from 5 to 15 mm.

18. The process according to claim 2, wherein the particulate inert support is provided in the form of spheres, cylinders, rings or columns.

19. The process according to claim 2, wherein the particulate inert support is provided in the form of spheres, cylinders, rings or columns, with dimensions of from 5 to 15 mm.

20. The process according to claim 3, wherein the particulate inert support is provided in the form of spheres, cylinders, rings or columns.
